(19) United States
(12) Patent Application Publication
(10) Pub. No.: US 2013/0011719 A1
(43) Pub. Date: Jan. 10, 2013

(54) BATTERY MODULE AND BATTERY ASSEMBLY USED THEREIN

(75) Inventors: Shunsuke Yasui, Osaka (JP); Masatoshi Nagayama, Osaka (JP); Takuya Nakashima, Osaka (JP)

(73) Assignee: PANASONIC CORPORATION, Osaka (JP)

(21) Appl. No.: 13/635,817

(22) PCT Filed: Jan. 17, 2012
(86) PCT No.: PCT/JP2012/000246

§ 371 Date: Sep. 18, 2012

(30) Foreign Application Priority Data
Jan. 25, 2011 (JP) 2011-012599
Mar. 23, 2011 (JP) 2011-063842

(51) Int. Cl. H01M 2/10; H01M 10/02

(52) U.S. Cl. 429/159

(57) ABSTRACT

A battery assembly 200 includes: a block 80 including housings 80a each housing cells 100; first and second connection plates 21 and 22 connecting the cells 100 in parallel; and a spacer 90 disposed between the cell 100 and the first connection plate 21. The block 80 has a pierced part 80b penetrating the block 80 along the axial direction. The spacer 90 has a hollow part 90a penetrating the spacer 90 along the axial direction. A battery module is formed by combining the battery assemblies 200 such that the pierced part 80b of one of adjacent ones of the battery assemblies 200 disposed along the stacking direction is engaged with the hollow part 90a of the other battery assembly 200. The pierced parts 80b and the hollow parts 90a of the battery assemblies 200 communicate with each other along the axial direction.

### TECHNICAL FIELD

The present disclosure relates to battery modules in each of which multiple battery assemblies each including batteries are stacked, and battery assemblies for use in such battery modules.

### BACKGROUND ART

Battery packs in each of which a plurality of batteries are housed in a case so as to output a predetermined voltage and have a predetermined capacity are widely used as power sources for, for example, various equipment and vehicles. For these batteries packs, there is a newly employed technique of connecting general-purpose batteries in parallel or in series to form modules of battery assemblies each outputting a predetermined voltage and having a predetermined capacity and of variously combining such battery modules to comply with various applications. This module technique enables reduction in size and weight of battery modules by enhancing performance of batteries housed in the battery modules, and therefore, has advantages such as improved workability in packaging battery packs and high flexibility in installing the battery modules in limited space of vehicles or other equipment.

For example, battery modules using lithium ion secondary batteries have been developed as power sources for vehicles or other equipment. There is a demand for only battery modules using lithium ion secondary batteries but also battery modules in which a plurality of battery assemblies are connected in series or in parallel to obtain optimum high-power and large-capacity characteristics according to the type of batteries.

Patent Document 1 describes a battery module including battery assemblies in each of which a plurality of batteries are housed in a case. Specifically, the battery module of Patent Document 1 is configured such that the cases are fastened together with bolts inserted into through holes in the peripheries of the cases and the battery assemblies are cooled by causing cooling air to flow into space provided between the battery assemblies.

### CITATION LIST

### Patent Document

Patent Document 1: Japanese Patent Publication No. 2006-147531

### SUMMARY OF THE INVENTION

### Technical Problem

In the technique described in Patent Document 1, however, the battery module is formed by fastening the battery assemblies together, and thus, positioning of the battery assemblies is difficult and assembly and disassembly of the battery module are complicated. In addition, in a case where batteries are arranged in multiple rows in each of the battery assemblies, batteries located near the center of the battery assembly are exposed to heat from batteries located in the periphery of the battery assembly, and are not susceptible to cooling by cooling air flowing in the space between the battery assemblies. Accordingly, batteries in the battery assemblies are less likely to have a uniform temperature.

It is therefore an object of the present disclosure to provide a battery module which can be easily assembled or disassembled by using a combination of battery assemblies and can uniformize the temperatures of batteries in the battery assemblies.

### Solution to the Problem

A battery module according to the present disclosure is a battery module including a plurality of stacked battery assemblies. Each of the battery assemblies includes a block including a plurality of housings each of which houses a plurality of cylindrical cells such that electrodes of the cells having an identical polarity are located at one side, a first connection plate connecting the electrodes of the cells having the identical polarity in parallel, a second connection plate connecting electrodes of the cells having the other polarity in parallel, and a spacer disposed between the cells and the first connection plate.

The block has a pierced part penetrating the block along an axial direction, the spacer has a hollow part extending outward from the first connection plate and penetrating the spacer along the axial direction, adjacent ones of the battery assemblies disposed along a stacking direction are combined such that the pierced part of one of the adjacent ones of the battery assemblies is engaged with the hollow part of the other battery assembly, and in the stacked battery assemblies, the pierced parts and the hollow parts of the battery assemblies communicate with each other along the axial direction.

In the foregoing configuration, the pierced part of one of the adjacent ones of the battery assemblies is engaged with the hollow part of the other battery assembly, thereby easily stacking and combining the battery assemblies. In addition, by allowing the pierced parts and the hollow parts of the battery assemblies to communicate with each other along the axial direction, the cells arranged around the pierced parts can be efficiency cooled. As a result, it is possible to achieve a battery module which can be easily assembled or disassembled by using a combination of battery assemblies and can uniformize the temperatures of the cells in the battery assemblies.

Another battery module according to the present disclosure is a battery module including a plurality of battery assemblies which are stacked and in each of which a plurality of cells are arranged such that electrodes of the cells having an identical polarity are located at one side, and each of the battery assemblies includes a first connection plate connecting the electrodes of the cells having the identical polarity in parallel; a second connection plate connecting electrodes of the cells having the other polarity in parallel, and a cylindrical pierced part including a first pierced part and a second pierced part with different outer diameters.

The first pierced part extends outward through a first opening formed in the first connection plate, adjacent ones of the battery assemblies disposed along a stacking direction are combined such that the first pierced part of one of the adjacent ones of the battery assemblies is engaged with the second pierced part of the other battery assembly, and the pierced parts of the stacked battery assemblies communicate with each other along an axial direction.

In the foregoing configuration, the first pierced part of one of the adjacent ones of the battery assemblies is engaged with the second pierced part of the other battery assembly, thereby easily stacking and combining the battery assemblies. In addition, by allowing the pierced parts of the battery assemblies to communicate with each other along the axial direction, the cells arranged around the pierced parts can be efficiency cooled. As a result, it is possible to achieve a battery module which can be easily assembled or disassembled by using a combination of battery assemblies and can uniformize the temperatures of the cells in the battery assemblies.

### Advantages of the Invention

According to the present disclosure, it is possible to achieve a battery module which can be easily assembled or disassembled by using a combination of battery assemblies and can uniformize the temperatures of the cells in the battery assemblies.

### BRIEF DESCRIPTION OF THE DRAWINGS

FIG. 1 is a cross-sectional view illustrating a configuration of a cell for use in a battery assembly according to a first embodiment of the present disclosure.

FIG. 2(a) is a top view of the battery assembly of the first embodiment, and FIG. 2(b) is a cross-sectional view taken along line B-B in FIG. 2(a).

FIG. 3(a) is a top view of a block according to the first embodiment, and

FIG. 3(b) is a cross-sectional view taken along line B-B in FIG. 3(a).

FIG. 4(a) is a top view of a spacer according to the first embodiment, and FIG. 4(b) is a cross-sectional view taken along line B-B in FIG. 4(a).

FIG. 5 is a cross-sectional view illustrating a configuration of a battery module according to the first embodiment.

FIG. 6(a) is a front view of the battery module of the first embodiment, and FIG. 6(b) is a cross-sectional view taken along line B-B in FIG. 6(a).

FIG. 7 is a front view illustrating a state in which the battery modules of the first embodiment are stacked.

FIG. 8(a) is a top view of a battery assembly according to a variation of the first embodiment, and FIG. 8(b) is a cross-sectional view taken along line B-B in FIG. 8(a).

FIG. 9(a) is a top view of a block according to the variation of the first embodiment, and FIG. 9(b) is a cross-sectional view taken along line B-B in FIG. 9(a)

FIG. 10(a) is a top view of a spacer according to the variation of the first embodiment, and FIG. 10(b) is a cross-sectional view taken along line B-B in FIG. 10(a).

FIG. 11 is a front view of a battery module according to the variation of the first embodiment.

FIG. 12 is a cross-sectional view of a battery module according to another variation of the first embodiment.

FIG. 13(a) is a top view of a battery assembly according to a second embodiment of the present disclosure, and FIG. 13(b) is a cross-sectional view taken along line B-B in FIG. 13(a).

FIG. 14 is a cross-sectional view illustrating the configuration of a battery module according to the second embodiment.

FIG. 15 is a cross-sectional view of the battery module of the second embodiment.

FIG. 16 is a cross-sectional view illustrating battery assemblies and a battery module formed by stacking the battery assemblies according to a variation of the second embodiment.

FIG. 16 is a cross-sectional view illustrating battery assemblies and a battery module formed by stacking the battery assemblies according to another variation of the second embodiment.

### DESCRIPTION OF EMBODIMENTS

Embodiments of the present disclosure will be described in detail hereinafter with reference to the drawings. The present disclosure is not limited to the following embodiments. Various changes and modifications may be made without departing from the scope of the invention. The following embodiments may be combined with other embodiments.

### First Embodiment

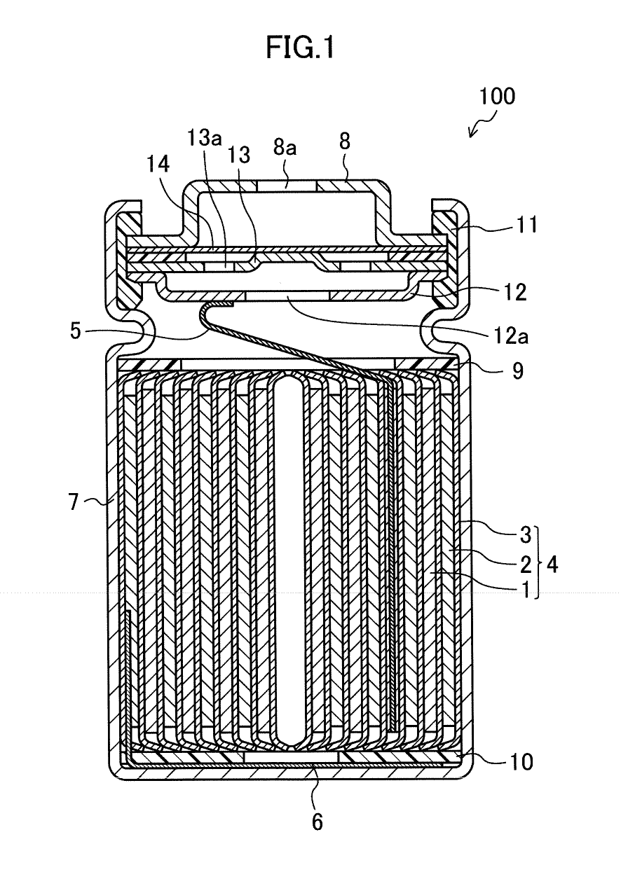

FIG. 1 is a cross-sectional view schematically illustrating a configuration of a battery (hereinafter referred to as a “cell”) 100 for use in a battery assembly according to a first embodiment of the present disclosure.

The cell 100 constituting a battery assembly according to the present disclosure can be, for example, a cylindrical lithium ion secondary battery illustrated in FIG. 1.

This lithium ion secondary battery may be a general-purpose battery for use in a power source of mobile electronic equipment such as a laptop computer. In this case, since a general-purpose battery with high-performance can be used as a cell of a battery module, enhanced performance and cost reduction of the battery module can be more easily achieved. The cell 100 has a safety mechanism which releases a gas to outside the cell when the pressure in the cell increases due to generation of, for example, an internal short circuit. A specific configuration of the cell 100 will be described below with reference to FIG. 1.

As illustrated in FIG. 1, an electrode group 4 formed by winding a positive electrode 1 and a negative electrode 2 with a separator 3 interposed therebetween is housed in a battery case 7 together with a nonaqueous electrolyte. Insulating plates 9 and 10 are disposed at the top and the bottom, respectively, of the electrode group 4. The positive electrode 1 is joined to a filter 12 with a positive electrode lead 5 interposed therebetween. The negative electrode 2 is joined to the bottom of the battery case 7 with a negative electrode lead 6 interposed therebetween. The bottom of the battery case 7 also serves as a negative electrode terminal.

The filter 12 is connected to an inner cap 13 having a projection joined to a metal valve 14. The valve 14 is connected to a terminal plate 8, which also serves as a positive electrode terminal. The terminal plate 8, the valve 14, the inner cap 13, and the filter 12 together seal an opening of the battery case 7 with a gasket 11 interposed therebetween.

When an internal short circuit, for example, occurs in the cell 100 to increase the pressure in the cell 100, the valve 14 expands toward the terminal plate 8. Then, when the joint between the inner cap 13 and the valve 14 is broken, a current path is blocked. Thereafter, when the internal pressure of the cell 100 further increases, the valve 14 is broken. Accordingly, a gas generated in the cell 100 is released to outside the cell 100 through a through hole 12a in the filter 12, a through hole 13a in the inner cap 13, a cleavage in the valve 14, and an aperture 8a in the terminal plate 8 in this order.

The safety mechanism for releasing a gas generated in the cell 100 to outside the cell 100 is not limited to the structure illustrated in FIG. 1, and may have other structures.

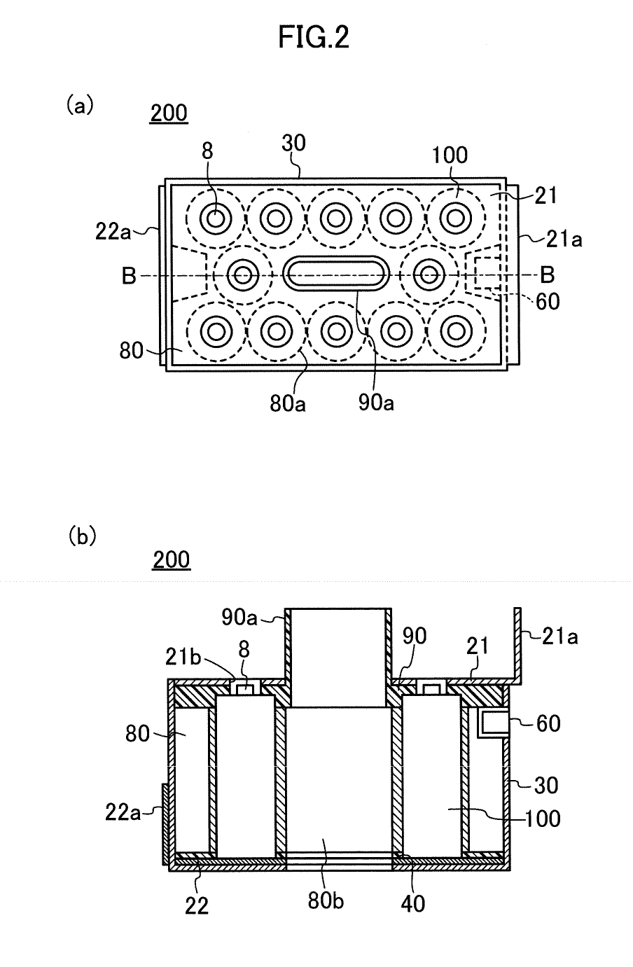

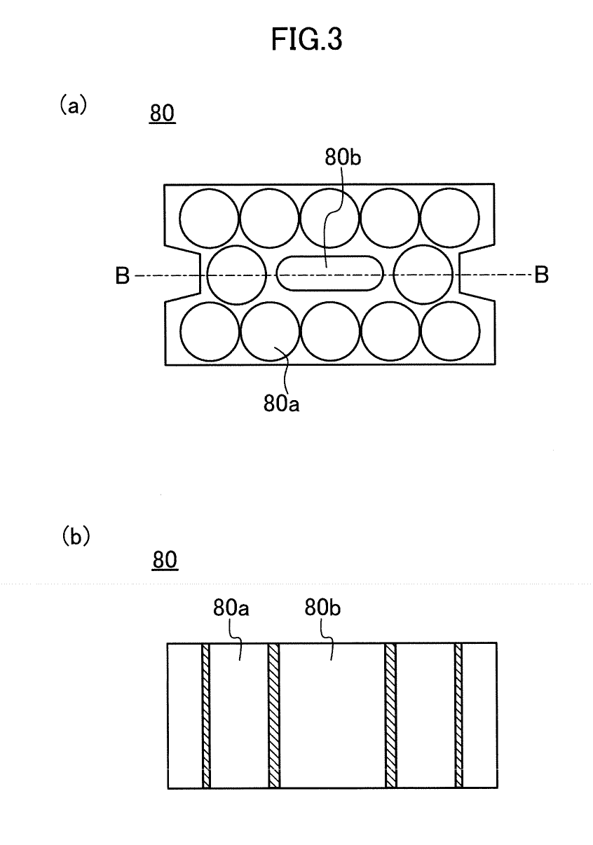

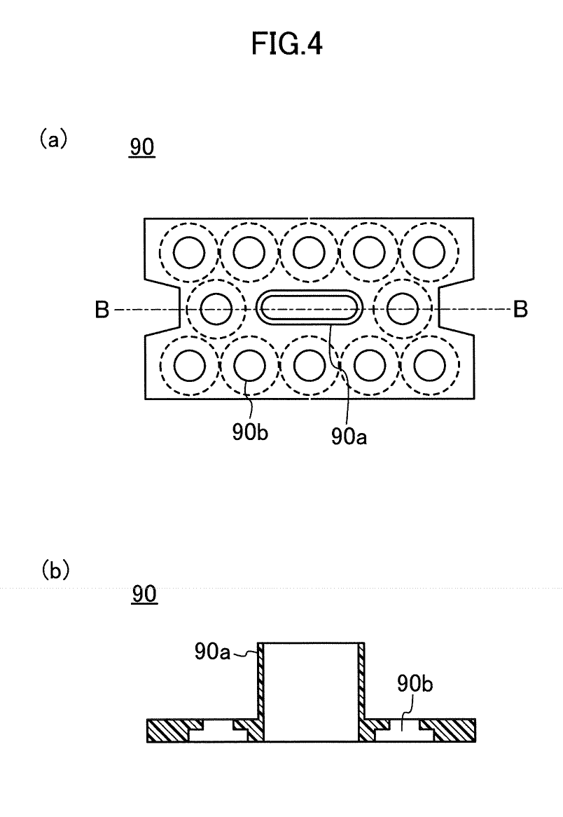

Referring now to FIGS. 2(a), 2(b), 3(a), 3(b), 4(a), and 4(b), a configuration of a battery assembly 200 in this embodiment will be described. FIG. 2(a) is a top view of the battery assembly 200, and FIG. 2(b) is a cross-sectional view taken along line B-B in FIG. 2(a). FIG. 3(a) is a top view of a block 80 constituting the battery assembly 200, and FIG. 3(b) is a cross-sectional view taken along line B-B in FIG. 3(a). FIG. 4(a) is a top view of a spacer 90 constituting the battery assembly 200, and FIG. 4(b) is a cross-sectional view taken along line B-B in FIG. 4(a).

The battery assembly 200 of this embodiment includes: the block 80 including a plurality of housings 80a each of which houses a plurality of cylindrical cells 100 such that electrodes of the cells 100 having an identical polarity are located at one side; a positive electrode connection plate (a first connection plate) 21 connecting positive electrode terminals (electrodes having an identical polarity) 8 of the cells 100 in parallel; a negative electrode connection plate (a second connection plate) 22 connecting negative electrode terminals (the bottoms of the battery cases 7; electrodes having the other polarity) of the cells 100 in parallel; and a spacer 90 disposed between the cells 100 and the positive electrode connection plate 21.

As illustrated in FIGS. 3(a) and 3(b), the block 80 has a pierced part 80b penetrating the block 80 along the axial direction. The housings 80a of the block 80 are arranged around the pierced part 80b.

As illustrated in FIGS. 4(a) and 4(b), the spacer 90 has a hollow part 90a extending outward from the positive electrode connection plate 21 and penetrating the spacer 90 along the axial direction. In a case where the positive electrode connection plate 21 covers the hollow part 90a, an opening (a first opening) is formed in the positive electrode connection plate 21 so that the hollow part 90a extends outward through the opening in the positive electrode connection plate 21.

The positive electrode connection plate 21 has a positive electrode connection terminal (a first connection terminal) 21a extending in the direction opposite to the direction toward the negative electrode connection plate 22. The negative electrode connection plate 22 has a negative electrode connection terminal (a second connection terminal) 22a extending in the same direction as that of the positive electrode connection terminal 21a.

Referring now to FIGS. 2(a), 2(b), 3(a), 3(b), 4(a), and 4(b), the configuration of the battery assembly 200 of this embodiment will be more specifically described.

The cells 100 are housed in the housings 80a of the block 80 made of a metal such as aluminium. The housings 80a have an inner diameter larger than the outer diameter of the cells 100 by about 0.1-1 mm so that the cells 100 can be housed. The pierced part 80b is provided through the center of the block 80 along the axial direction substantially in parallel with the housings 80a.

The positive electrode connection plate 21 connecting the positive electrode terminals 8 of the cells 100 in parallel is disposed near the positive electrode terminals 8 of the cells 100, and the negative electrode connection plate 22 connecting the negative electrode terminals in parallel is disposed near the negative electrode terminals (the bottoms of the battery cases 7) of the cells 100. In this manner, in a battery module (and further a battery pack as a group of battery modules) as a combination of the battery assemblies 200, even when a failure occurs in one of the cells 100 constituting the battery assembly 200, a current supply of the battery module (and further the battery pack) can be ensured.

In addition, the positive electrode connection plate 21 has a positive electrode connection terminal 21a formed by bending an end of the positive electrode connection plate 21. The negative electrode connection plate 22 has a negative electrode connection terminal 22a formed by bending an end of the negative electrode connection plate 22.

The spacer is disposed between the positive electrode connection plate 21 and the cells 100. The hollow part (the center assembly part) 90a is formed at the center of the spacer 90 to communicate with the pierced part 80b of the block 80.

The outer diameter of the hollow part 90a is substantially equal to the inner diameter of the pierced part 80b such that the pierced part 80b and the hollow part 90a can be engaged with each other in combining the battery assemblies 200, which will be described later. In addition, to electrically connect the positive electrode connection terminal 21a and the negative electrode connection terminal 22a to each other in combining the battery assemblies 200, the inner size of the positive electrode connection terminal 21a from the hollow part 90a and the outer size of the negative electrode connection terminal 22a from the hollow part 90a are substantially the same. That is, the positive electrode connection terminal 21a is located outward relative to the negative electrode connection terminal 22a by the distance corresponding to the thickness of the negative electrode connection terminal 22a.

As illustrated in FIG. 2(b), the positive electrode connection terminal 21a and the negative electrode connection terminal 22a are preferably disposed at opposite sides relative to the hollow part 90a. In this case, in electrically connecting the positive electrode connection terminal 21a and the negative electrode connection terminal 22a by combining the battery assemblies 200, current paths of all the cells 100 have substantially the same distance between each adjacent ones of the battery assemblies 200. As a result, the degree of consumption can be made uniform among all the cells 100.

A case 30 is made of a heat-resistance insulating material such as a ceramic plate or a coated plate formed by coating the surface of a metal material such as iron with an insulator. In combining the battery assemblies 200, the positive electrode connection plate 21 is substantially surrounded by the cases 30 of the combined battery assemblies 200. Accordingly, in the combined battery assemblies 200, components except for the positive electrode connection terminals 21 a and the negative electrode connection terminals 22a are electrically insulated, thereby reducing electric shock due to contact.

A terminal 60 for measurement may be embedded in the side of the cases 30. The measurement terminal 60 is a terminal for use in measurement of the temperature and voltage of the battery assemblies 200, and is connected to the positive electrode connection plates 21 or the negative electrode connection plates 22 of the battery assemblies 200. The temperature and voltage of the battery assemblies 200 can be measured by connecting an external terminal of measurement equipment to the measurement terminal 60. In this manner, a conductive part of the measurement terminal 60 is also hidden in the cases 30.

The positive electrode connection plate 21 is provided in close contact with an end (which is an end toward the positive electrode terminal 8 in this embodiment) of each of the cells 100 with the spacer 90 interposed therebetween. The apertures 8a of the cells 100 communicate with the outside through the through holes 21b formed in the positive electrode connection plate 21. Accordingly, a high-temperature gas from the apertures 8a of the cells 100 is released to the outside through the through holes 21b in the positive electrode connection plate 21. The spacer 90 also has an opening which communicates with an associate one of the through hole 21b in the positive electrode connection plate 21.

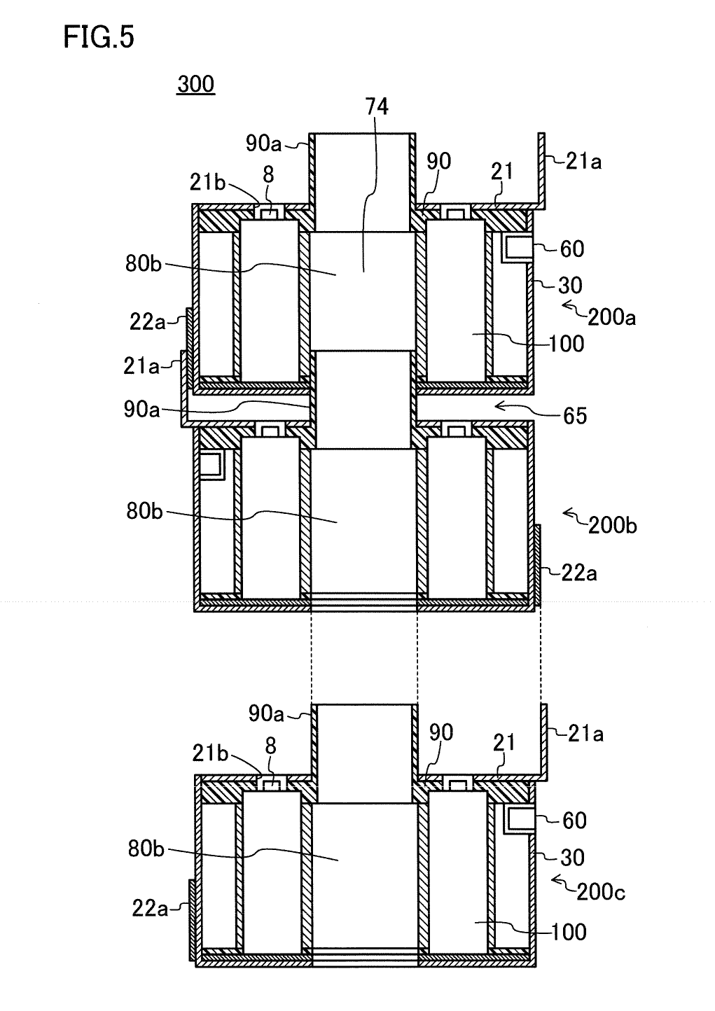

Referring now to FIG. 5, a configuration of a battery module 300 according to this embodiment will be described. FIG. 5 is a cross-sectional view illustrating a configuration of the battery module 300 of this embodiment, and showing a battery assembly 200a and a battery assembly 200b which have been already combined and a battery assembly 200c yet to be combined.

As illustrated in FIG. 5, the battery module 300 of this embodiment has a configuration in which the multiple battery assemblies 200a-200c are stacked. In this embodiment, the battery assemblies 200a and 200b adjacent to each other in the stacking direction are combined such that the pierced part 80b of the battery assembly 200a is engaged with the hollow part 90a of the battery assembly 200b. The pierced parts 80b and the hollow parts 90a of the stacked battery assemblies communicate with each other along the axial direction. The battery assembly 200b and the battery assembly 200c are stacked in the same manner.

By engaging the pierced part 80b of the battery assembly 200a with the hollow part 90a of the battery assembly 200b in the manner described above, the battery assemblies 200 can be easily stacked to be combined. In addition, by allowing the pierced parts 80b and the hollow parts 90a of the battery assemblies 200 to communicate with each other along the axial direction, the cells 100 arranged around the pierced parts 80b can be efficiency cooled. In this manner, it is possible to achieve a battery module which can be easily assembled or disassembled by using a combination of the battery assemblies 200 and can uniformize the temperature of the cells 100 in the battery assemblies 200.

In the battery assemblies 200a and 200b adjacent to each other in the stacking direction, the positive electrode connection terminal (the first connection terminal) 21a of the battery assembly 200a and the negative electrode connection terminal (the second connection terminal) 22a of the battery assembly 200b are in contact with each other and connected in series.

This configuration allows the positive electrode connection terminal 21a of the battery assembly 200a and the negative electrode connection terminal 22a of the battery assembly 200b to be connected in series simultaneously with combination of the battery assemblies 200a and 200b, thereby easily assembling or disassembling the battery assemblies 200.

The shapes of the pierced part 80b and the hollow part 90a are not specifically limited. For example, the pierced part 80b and the hollow part 90a may have hollow cylindrical shapes. In this case, the outer peripheral surface of the hollow part 90a is engaged with the inner peripheral surface of the pierced part 80b.

In a case where the negative electrode connection plate 22 covers the pierced part 80b, an opening (a second opening) is formed in the negative electrode connection plate 22 of the battery assembly 200a so that the hollow part 90a of the battery assembly 200b is engaged with the pierced part 80b of the battery assembly 200a through the opening.

The battery assemblies 200a and 200b adjacent to each other in the stacking direction are combined with space 65 provided along the axial direction. As illustrated in FIG. 1, the positive electrode terminal 8 of each of the cells 100 has the aperture 8a through which a gas generated in the cell 100 is released to outside the cell 100. The gas released through the aperture 8a of the cell 100 passes through the through hole 21b in the positive electrode connection plate 21 and then is released to the space 65 provided between the battery assemblies 200a and 200b adjacent to each other in the stacking direction.

Referring to FIG. 5, the configuration of the battery module 300 of this embodiment will be more specifically described.

As illustrated in FIG. 5, the battery assemblies 200a -200care arranged such that the positional relationship between the positive electrode and the negative electrode (i.e., the vertical direction in the drawing sheet) is the same among the battery assemblies 200a -200c and that the positive electrode connection terminals 21a and the negative electrode connection terminals 22a are alternately arranged at opposite sides (in the lateral direction in the drawing sheet). This arrangement allows the pierced part 80b of the battery assembly 200a and the hollow part 90a of the battery assembly 200b to be engaged with each other to be combined together. That is, in the stacked battery assemblies 200a -200c, the pierced parts 80b and the hollow parts 90a of the battery assemblies communicate with each other along the axial direction, resulting in that a cavity 74 penetrating the battery assemblies 200a -200c is formed in the center of the battery module 300.

The negative electrode connection terminal 22a of the battery assembly 200a and the positive electrode connection terminal 21a of the battery assembly 200b may be combined together, with the negative electrode connection terminal 22a of the battery assembly 200b being combined with the positive electrode connection terminal 21a of the battery assembly 200c.

As described above, the battery assembly 200 forms the cavity 74 penetrating the battery assemblies 200 in the center of the battery module 300 by combining the pierced parts 80b and the hollow parts 90a . Thus, cooling air flows in the cavity 74, i.e., the pierced parts 80b of the battery assemblies 200, to cool the battery assemblies 200. At this time, since the cells 100 are arranged around the pierced parts 80b, cooling is efficiency conducted. In particular, the metal block 80 conducts heat generated in the cells 100 to the pierced parts 80b, thereby enhancing cooling efficiency.

As described above, the inner size of the positive electrode connection terminal 21a from the hollow part 90a and the outer size of the negative electrode connection terminal 22a from the hollow part 90a are substantially the same. Thus, in combining the battery assemblies 200, the positive electrode connection terminal 21a and the negative electrode connection terminal 22a can be easily electrically connected to each other.

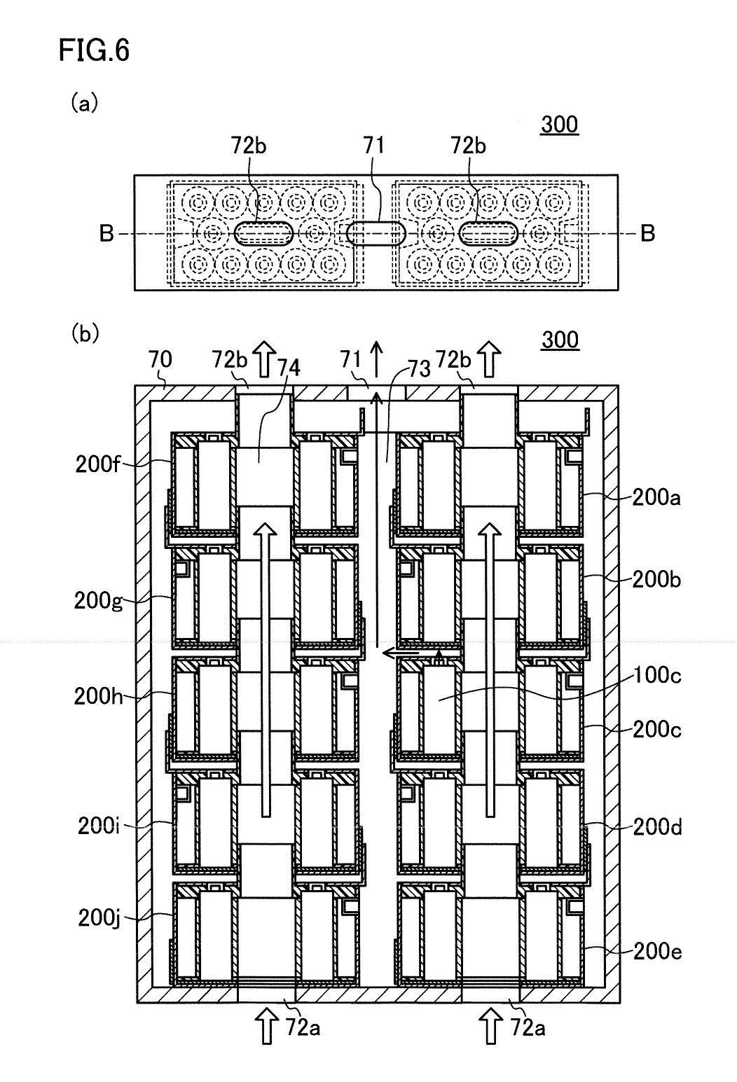

FIGS. 6(a) and 6(b) are views illustrating the battery module 300 housed in an external case 70. FIG. 6(a) is a front view, and FIG. 6(b) is a cross-sectional view taken along line B-B in FIG. 6(a).

The battery module 300 is housed in the external case 70 with a stack of the battery assemblies 200a-200e and a stack of the battery assemblies 200f-200j being arranged in two rows.

In this structure, when a gas is released from a cell 100c in the battery assembly 200c, as indicated by arrows in FIG. 6(b), the gas from the cell 100c passes through the through hole 21b formed in the positive electrode connection plate 21 of the battery assembly 200c, is released to the space 65 between the adjacent battery assemblies 200b and 200c, flows in space 73 in the external case 70, and then is released to outside the external case 70 from a vent 71 of the external case 70.

Since the cases 30 of the battery assemblies 200 are made of a heat-resistance insulating material such as a ceramic plate or a coated plate formed by coating the surface of a metal material such as iron with an insulator, even when a gas emitted from the through hole 21b of the battery assembly 200c directly strikes the case 30 of the battery assembly 200b, thermal properties of the battery assembly 200b are not adversely affected.

The hollow parts 90a of the battery assemblies 200a and 200f located at one end communicate with vents 72b formed in the upper surface of the external case 70. The pierced parts 80b of the battery assemblies 200e and 200j communicate with inlets 72a formed in the lower surface of the external case 70.

As illustrated in FIG. 6(b), the pierced parts 80b and the hollow parts 90 of the battery assemblies 200a-200e communicate with each other along the axial direction to form one cavity 74. Likewise, the pierced parts 80b and the hollow part 90 of the battery assemblies 200f-200j form another cavity 74. Accordingly, as indicated by the arrows in FIG. 6(b), cooling air taken through each of the inlets 72a of the external case 70 passes through an associated one of the cavities 74, and is released from an associated one of the vents 72b at the opposite side. In this manner, the cells in the battery assemblies 200a-200j can be efficiency cooled.

The cavities 74 in which cooling air flows are separated from other space in the external case 70. Thus, cooling air flowing in each of the cavities 74 does not flow into other space in the external case 70. Accordingly, a gas released from the cells 100 of the battery assemblies 200 to the space 73 of the external case 70 is released from the vent 71 of the external case 70 to outside the external case 70, while not being mixed with cooling air taken from the outside. As a result, it is possible to reduce combustion caused by reaction of a gas with cooling air in the external case 70.

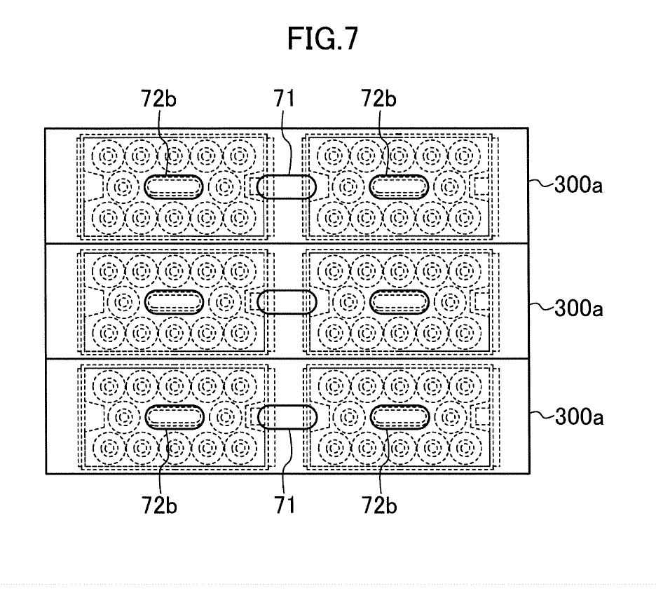

FIG. 7 is a front view illustrating a state in which a plurality of battery modules 300a-300c are stacked.

As illustrated in FIG. 7, each of the battery modules 300a-300c has the vent 72b at the center of the external case 70 thereof. Accordingly, when at least one of the cells 100 in the battery modules 300a-300c generates heat, the heat can be released from the vent 72b. Thus, heat released from the peripheries of the external case 70 of the battery modules 300a-300c does not need to be taken into consideration. For this reason, the battery modules 300a-300c can be arranged without providing clearance among the battery modules 300a-300c.

### Variations of First Embodiment

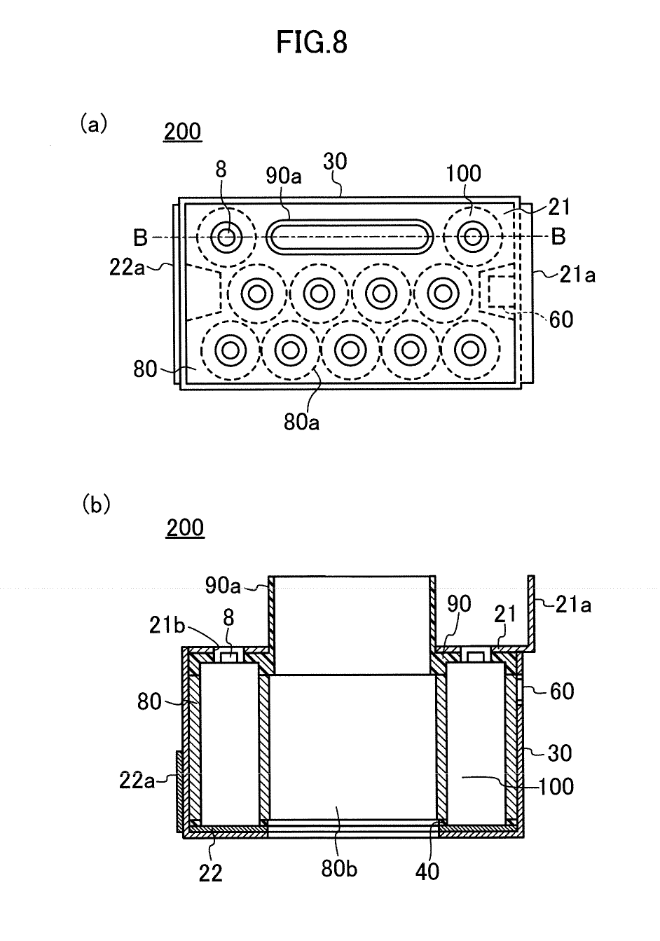

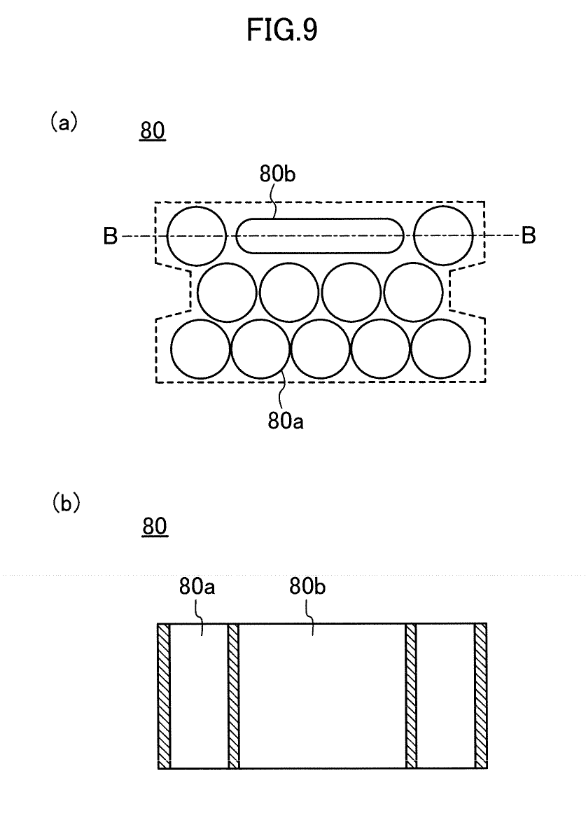

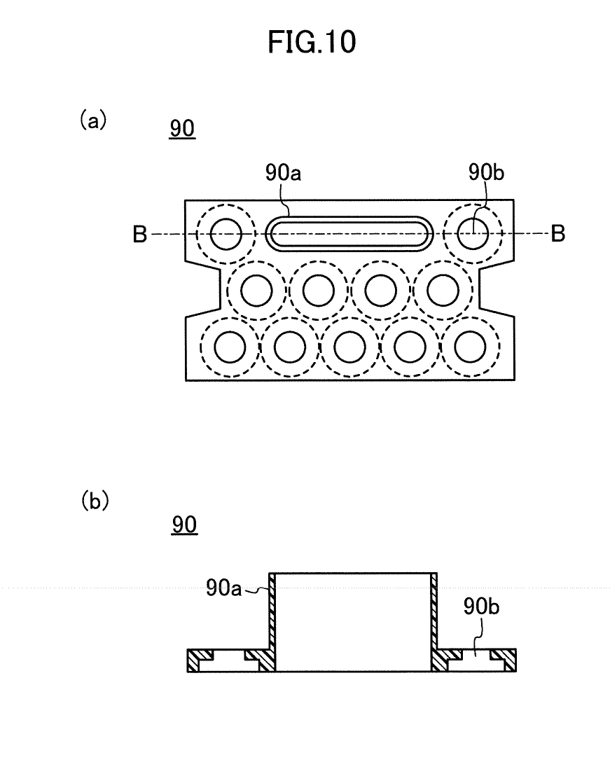

FIGS. 8(a), 8(b), 9(a), 9(b), 10(a), and 10(b) are views illustrating a configuration of a battery assembly 200 according to a variation of the first embodiment. FIG. 8(a) is a top view of the battery assembly 200, and FIG. 8(b) is a cross-sectional view taken along line B-B in FIG. 8(a). FIG. 9(a) is a top view of a block 80 constituting the battery assembly 200, and FIG. 9(b) is a cross-sectional view taken along line B-B in FIG. 9(a). FIG. 10(a) is a top view of a spacer 90 constituting the battery assembly 200, and FIG. 10(b) is a cross-sectional view taken along line B-B in FIG. 10(a).

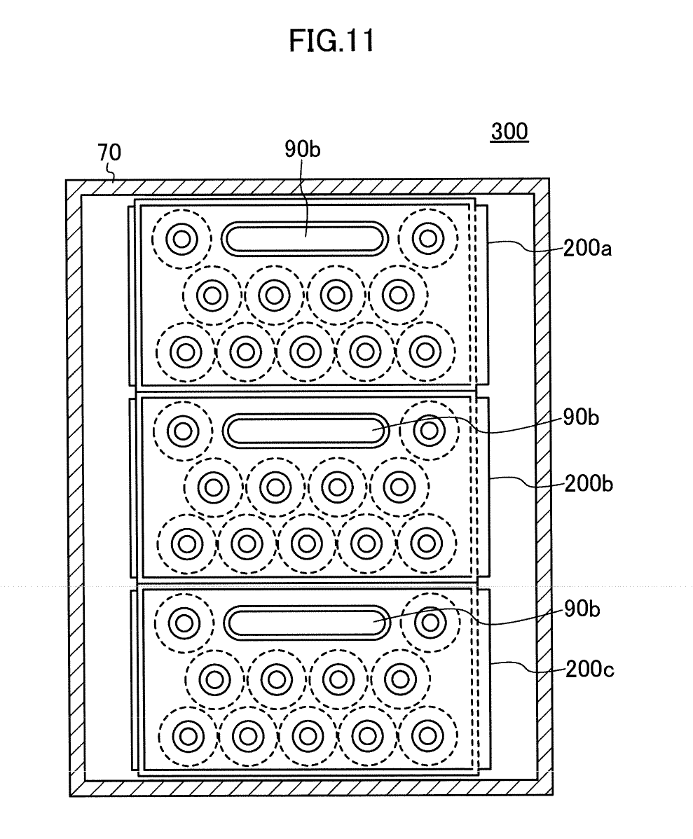

In this variation, a pierced part 80b and a hollow part 90a of the battery assembly 200 are located in a peripheral portion of a case 30. In this case, as illustrated in FIG. 11, battery assemblies 200a-200c are stacked to form a battery module 300 such that cavities formed by the pierced parts 80b and the hollow parts 90a are disposed at the same side, thereby cooling the cells 100 located at the bottom of the uppermost battery assembly 200a with cooling air flowing in the cavity of its underlying battery assembly 200b. In this manner, even when the battery assemblies 200a-200c are stacked, all the cells 100 in the battery assemblies 200a-200c arranged in the peripheral portions of the cavities can be efficiency cooled, thereby uniformizing the temperature of the cells 100.

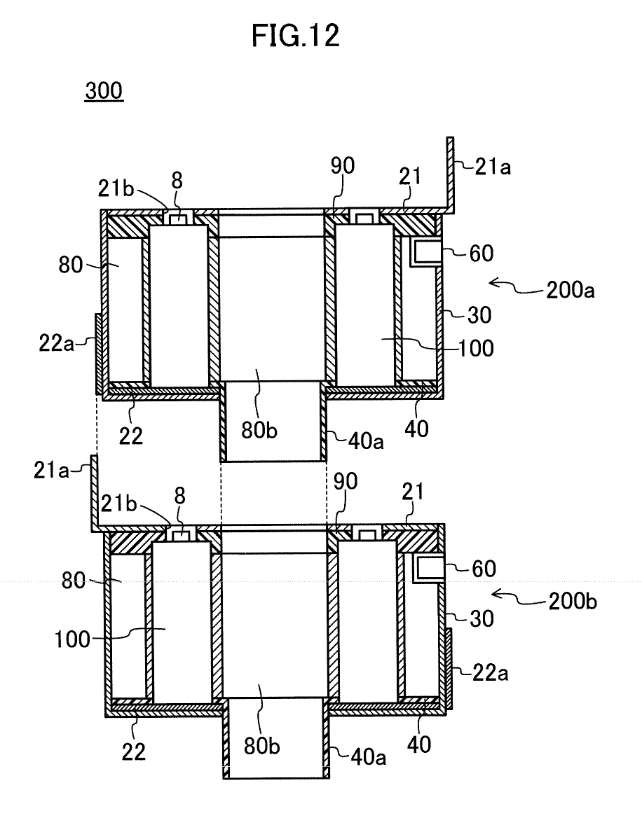

FIG. 12 is a cross-sectional view illustrating configurations of battery assemblies 200 and a battery module 300 formed by stacking the battery assemblies 200 according to another variation of the first embodiment.

In this variation, a spacer 40 provided between a cell 100 and a negative electrode connection plate 22 has a hollow part 40a penetrating the spacer 40 along the axial direction. In this case, the hollow part 40a extends outward from the negative electrode connection plate 22. A pierced part 80b housing the cells 100 has the same configuration as that illustrated in FIG. 2(b).

In the battery module 300, battery assemblies 200a and 200b adjacent to each other in the stacking direction are combined such that the hollow part 40a of the battery assembly 200a is engaged with the pierced part 80b of the battery assembly 200b. Consequently, in the stacked battery assemblies 200a and 200b, the pierced part 80b and the hollow part 40a of the battery assemblies 200a and 200b communicate with each other along the axial direction.

In a case where the negative electrode connection plate 22 covers the hollow part 40a, an opening is formed in the negative electrode connection plate 22 so that the hollow part 40a extends outward through the opening in the negative electrode connection plate 22.

In a case where the positive electrode connection plate 21 covers the pierced part 80b, the hollow part 40a of the battery assembly 200a is engaged with the pierced part 80b of the battery assembly 200b through an opening formed in the positive electrode connection plate 21 of the battery assembly 200b.

### Second Embodiment

In the first embodiment, the block 80 housing the cells 100 has a pierced part 80b, and the spacer 90 or 40 provided between the cell 100s and either the positive electrode connection plate 21 or the negative electrode connection plate 22 has a hollow part 90a or 40a. The battery assemblies 200 adjacent to each other in the stacking direction are combined by engaging the pierced part 80b of one of the battery assemblies 200 with the hollow part 90a or 40a of the other battery assembly 200. In this manner, the battery module 300 is formed. That is, the inner diameter of the pierced part 80b is substantially equal to the outer diameter of the hollow part 90a or 40a, thereby making it possible to engage the pierced part 80b of one of the battery assemblies 200 with the hollow part 90a or 40a of the other battery assembly 200.

In a second embodiment of the present disclosure, a block 80 and a spacer 40 do not have a pierced part 80b and a hollow part 90a or 40a. Instead, each battery assembly 200 has a cylindrical pierced part including first and second pierced parts with different outer diameters.

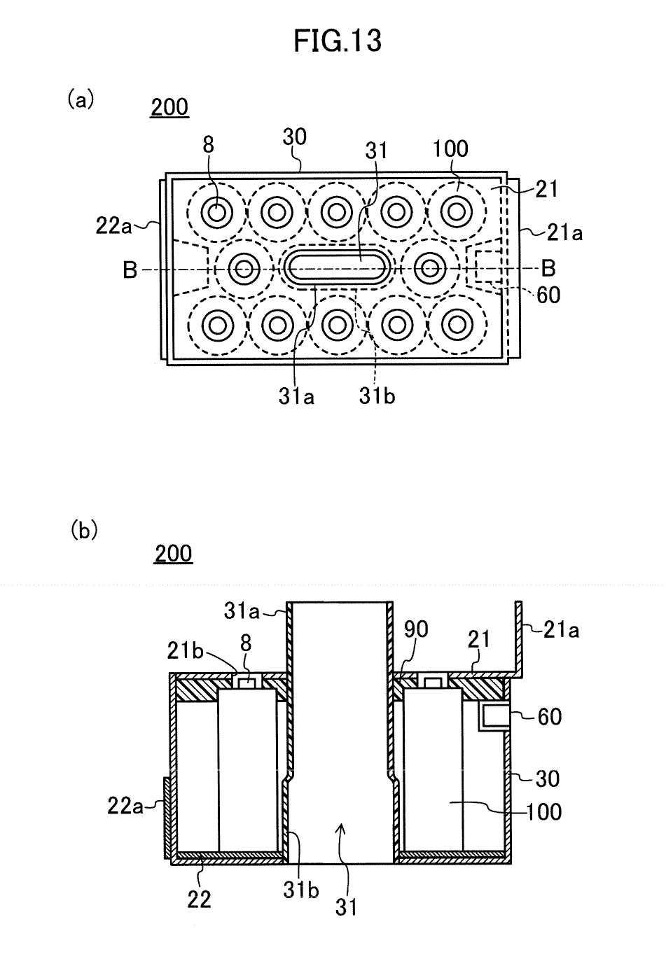

FIG. 13 illustrates a configuration of a battery assembly 200 of the second embodiment. FIG. 13(a) is a top view of a battery assembly 200, and FIG. 13(b) is a cross-sectional view taken along line B-B in FIG. 13(a).

The battery assembly 200 of this embodiment includes: cells 100 which are arranged such that electrodes of the cells 100 having an identical polarity are located at one side; a positive electrode connection plate (a first connection plate) 21 connecting positive electrode terminals (electrodes having an identical polarity) 8 of the cells 100 in parallel; a negative electrode connection plate (a second connection plate) 22 connecting negative electrode terminals (the bottoms of battery cases 7; electrodes having the other polarity) of the cells 100 in parallel; and a cylindrical pierced part 31 including first and second pierced parts 31a and 31b with different outer diameters.

As illustrated in FIG. 13(a), the cells 100 are arranged around the pierced part 31. The outer diameter of the first pierced part 31 a is substantially equal to the inner diameter of the second pierced part 31b. As illustrated in FIG. 13(b), the first pierced part 31a extends outward through an opening (a first opening) formed in the positive electrode connection plate 21.

The positive electrode connection plate 21 has a positive electrode connection terminal (a first connection terminal) 21a extending in the direction opposite to the direction toward the negative electrode connection plate 22. The negative electrode connection plate 22 has a negative electrode connection terminal (a second connection terminal) 22a extending in the same direction as that of the positive electrode connection terminal 21a.

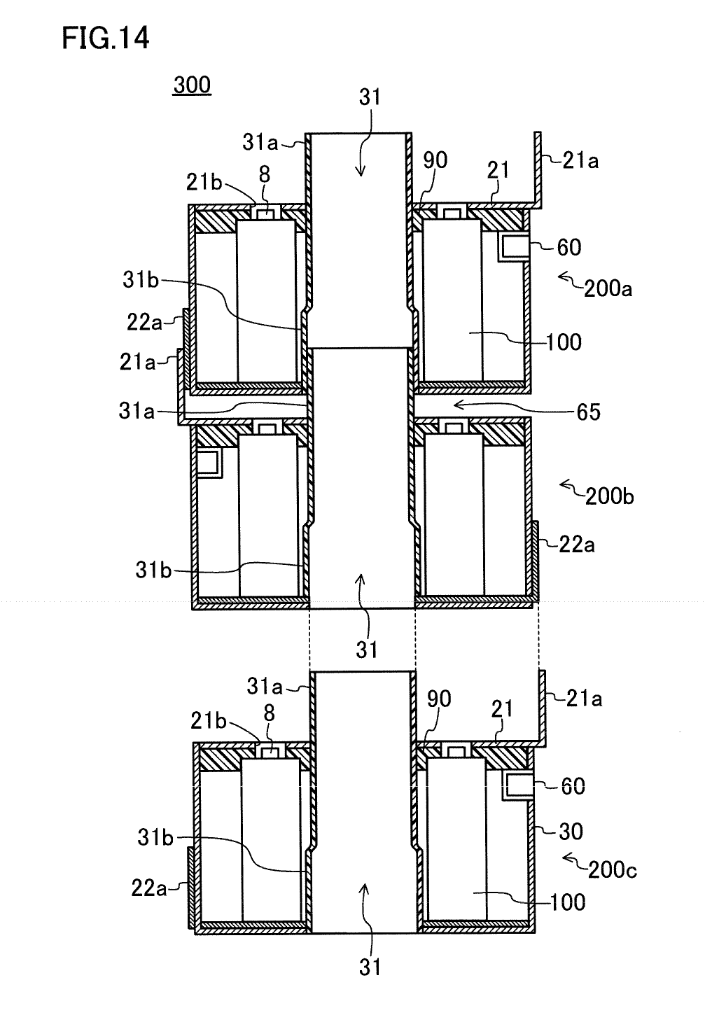

Referring now to FIG. 14, a configuration of the battery module 300 of this embodiment will be described. FIG. 14 is a cross-sectional view illustrating the configuration of the battery module 300 of this embodiment, and showing a battery assembly 200a and a battery assembly 200b which haven been already combined and a battery assembly 200c yet to be combined.

As illustrated in FIG. 14, the battery module 300 of this embodiment has a configuration in which a plurality of battery assemblies 200a-200c are stacked. In this embodiment, the battery assemblies 200a and 200b adjacent to each other in the stacking direction are combined such that the second pierced part 3 lb of the battery assembly 200a is engaged with the first pierced part 31a of the battery assembly 200b. The pierced parts 31 of the stacked battery assemblies 200 communicate with each other along the axial direction. The battery assembly 200b and the battery assembly 200c are stacked in the same manner.

In the foregoing configuration, by engaging the second pierced part 31b of the battery assembly 200a with the first pierced part 31a of the battery assembly 200b, the battery assemblies 200 can be easily stacked to be combined. In addition, by allowing the pierced parts 31 of the battery assemblies 200 to communicate with each other along the axial direction, the cells 100 arranged around the pierced parts 31 can be efficiency cooled. Accordingly, it is possible to achieve the battery module 300 which can be easily assembled or disassembled by using a combination of the battery assemblies 200 and can uniformize the temperature of the cells 100 in the battery assemblies 200.

In the battery assemblies 200a and 200b adjacent to each other in the stacking direction, the negative electrode connection terminal 22a of the battery assembly 200a and the positive electrode connection terminal 21a of the battery assembly 200b are in contact with each other and connected in series.

This configuration allows the negative electrode connection terminal 22a of the battery assembly 200a and the positive electrode connection terminal 21a of the battery assembly 200b to be connected in series simultaneously with combination of the battery assemblies 200a and 200b, thereby easily assembling or disassembling the battery assemblies 200.

The shapes of the first pierced part 31a and the second pierced part 31b are not specifically limited. For example, the first pierced part 31a and the second pierced part 31b may have hollow cylindrical shapes. In this case, the outer peripheral surface of the first pierced part 31a is engaged with the inner peripheral surface of the second pierced part 31b.

In a case where the negative electrode connection plate 22 covers the second pierced part 31b, an opening (a second opening) is formed in the negative electrode connection plate 22 of the battery assembly 200a so that the first pierced part 31a of the battery assembly 200b is engaged with the second pierced part 31b of the battery assembly 200a through the opening.

The battery assemblies 200a and 200b adjacent to each other in the stacking direction are combined with space 65 provided along the axial direction. As illustrated in FIG. 1, the positive electrode terminal 8 of each of the cells 100 has an aperture 8a through which a gas generated in the cell 100 is released to outside the cell 100. The gas released through the aperture 8a of the cell 100 passes through the through hole 21b in the positive electrode connection plate 21 and then is released to the space 65 provided between the battery assemblies 200a and 200b adjacent to each other in the stacking direction.

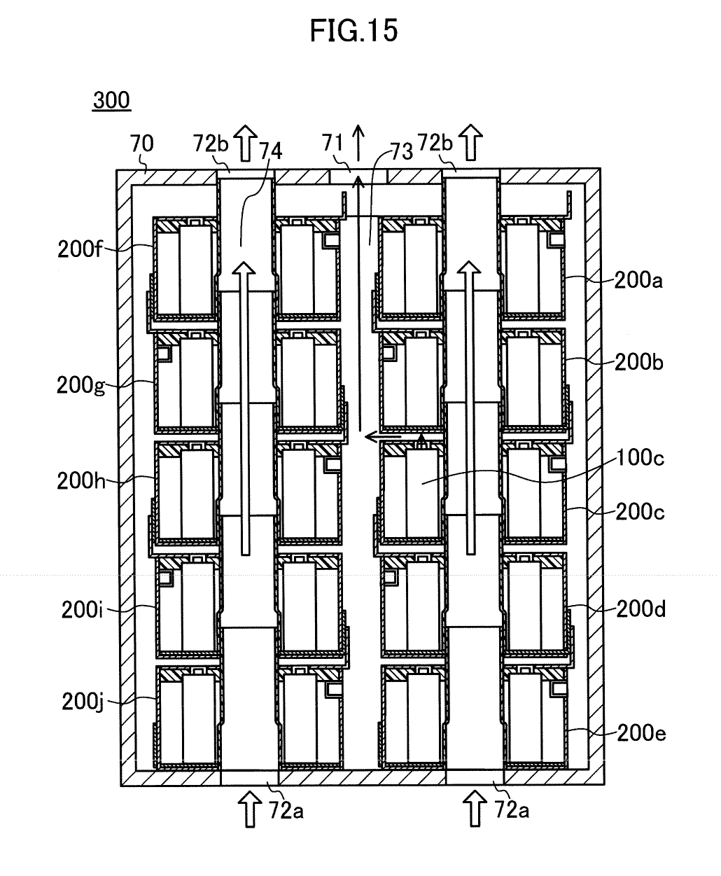

FIG. 15 is a cross-sectional view illustrating a configuration of the battery module 300 housed in an external case 70. The battery module 300 is housed in the external case 70 with a stack of the battery assemblies 200a-200e and a stack of the battery assemblies 200f-200j being arranged in two rows.

For example, when a gas is released from a cell 100c in the battery assembly 200c, as indicated by arrows in FIG. 15, the gas from the cell 100c passes through the through hole 21b formed in the positive electrode connection plate 21 of the battery assembly 200c , is released to the space 65 between the adjacent battery assemblies 200b and 200c, flows in space 73 in the external case 70, and then is released to outside the external case 70 from a vent 71 of the external case 70.

The first pierced parts 31 a of the battery assemblies 200a and 200f located at one end communicate with vents 72b formed in the upper surface of the external case 70. The second pierced parts 31b of the battery assemblies 200e and 200j located at the other end communicate with inlets 72a formed in the lower surface of the external case 70.

As illustrated in FIG. 15, the pierced parts 31 of the battery assemblies 200a-200e and 200f-200j communicate with each other along the axial direction to form one cavity 74. Accordingly, as indicated by the arrows in FIG. 15, cooling air taken through each of the inlets 72a of the external case 70 passes through an associated one of the cavities 74, and is released from an associated one of the vents 72b at the opposite side. In this manner, the cells in the battery assemblies 200a-200j can be efficiency cooled.

The cavities 74 in which cooling air flows are separated from other space in the external case 70. Thus, cooling air flowing in each of the cavities 74 does not flow into other space in the external case 70. Accordingly, a gas released from the cells 100 of the battery assemblies 200 to the space 73 of the external case 70 is released from the vent 71 of the external case 70 to outside the external case 70, while not being mixed with cooling air taken from the outside. As a result, it is possible to reduce combustion caused by reaction of a gas with cooling air in the external case 70.

### Variations of Second Embodiment

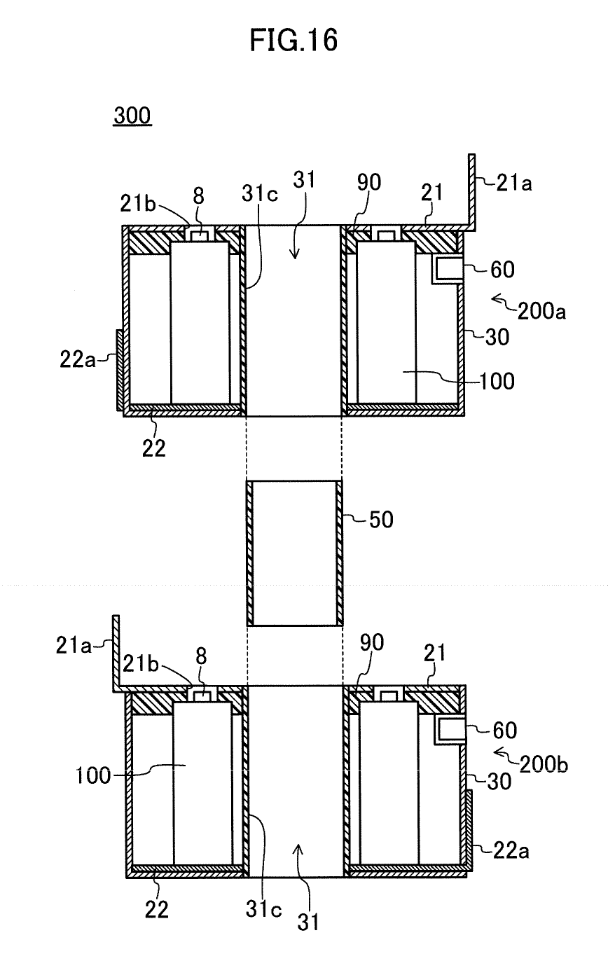

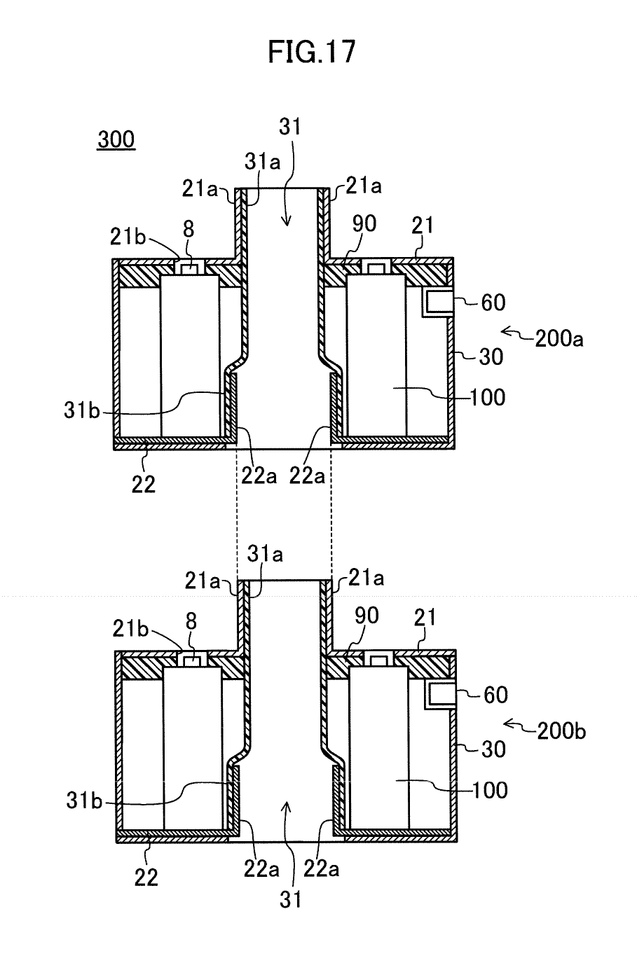

FIG. 16 is a cross-sectional view illustrating configurations of battery assemblies 200 and a battery module 300 in which the battery assemblies 200 are stacked according to a variation of the second embodiment.

In this variation, pierced parts 31 have hollow cylindrical shapes having a uniform inner diameter. Both ends of the pierced parts 31 penetrate a positive electrode connection plate 21 and a negative electrode connection plate 22. The pierced part 31 does not extend outward from the positive electrode connection plate 21 and the negative electrode connection plate 22.

In the battery module 300 of this variation, battery assemblies 200a and 200b adjacent to each other in the stacking direction are combined such that the pierced part 31 of the battery assembly 200a is engaged with the pierced part 31 of the battery assembly 200b with a cylindrical hollow connection part 50 interposed therebetween. Consequently, in the stacked battery assemblies 200a and 200b, the pierced parts 31 of the battery assemblies 200a and 200b communicate with the hollow connection part 50 along the axial direction.

FIG. 17 is a cross-sectional view illustrating configurations of battery assemblies 200 and a battery module 300 formed by stacking the battery assemblies 200a according to another variation of the second embodiment.

In this variation, a positive electrode connection plate 21 has a positive electrode connection terminal 21 a extending in the direction opposite to the direction toward the negative electrode connection plate 22 along the outer peripheral surface of the first pierced part 31a, and the negative electrode connection plate 22 has a negative electrode connection terminal 22a extending in the same direction as that of the positive electrode connection terminal 21a along the inner periphery of the second pierced part 31b.

In battery assemblies 200a and 200b adjacent to each other in the stacking direction of the battery module 300 of this variation, the second pierced part 31b of the battery assembly 200a and the first pierced part 31a of the battery assembly 200b are engaged with each other to be combined together, with the positive electrode connection terminal 21a and the negative electrode connection terminal 22a interposed therebetween. As a result, in the stacked battery assemblies 200a and 200b, the pierced parts 31 of the battery assemblies 200a and 200b communicate with each other along the axial direction.

To engage the second pierced part 31b of the battery assembly 200a with the first pierced part 31a of the battery assembly 200b, the outer diameter of the positive electrode connection terminal 21 a and the inner diameter of the negative electrode connection terminal 22a are made substantially the same.

With foregoing configuration, by engaging the second pierced part 31b of the battery assembly 200a with the first pierced part 31a of the battery assembly 200b, the battery assemblies 200 can be easily stacked to be combined, and at the same time, the battery assemblies 200 can be electrically connected to each other. Further, after combination of the battery assemblies 200, the positive electrode connection terminal 21a and the negative electrode connection terminal 22a are hidden in the battery assemblies 200, and thus, it is possible to reduce electric shock caused by contact of conductive parts.

The present disclosure has been described based on the foregoing preferred embodiments. However, these embodiments do not limit the present disclosure, and may be variously changed or modified.

For example, in the foregoing embodiments, the case 30 is made of a thermally conductive resin. Alternatively, the case 30 may be made of a metal plate coated with a resin layer. Then, the strength of the case can be enhanced, while increasing thermal conductivity.

In the foregoing embodiments, the positive electrode connection terminal 21 a and the negative electrode connection terminal 22a are brought into contact with each other by adjusting the dimensions of the terminals 21a and 22a. Alternatively, the terminals 21a and 22a may be welded together by TIG welding or laser welding, for example. Then, the positive electrode connection terminal 21a and the negative electrode connection terminal 22a can be more firmly combined.

### INDUSTRIAL APPLICABILITY

A battery module according to the present disclosure is useful as a power source for driving automobiles, electric motorcycles, or electric play equipment.

### DESCRIPTION OF REFERENCE CHARACTERS

1 positive electrode

2 negative electrode

3 separator

4 electrode group

7 battery case

8 positive electrode terminal

8a aperture

10 cell

11 gasket

21 positive electrode connection plate (first connection plate)

21 a positive electrode connection terminal (first connection terminal)

21b through hole

22 negative electrode connection plate (second connection plate)

22a negative electrode connection terminal (second connection terminal)

30 case

31 pierced part

31a first pierced part 31b second pierced part

40 spacer

40a hollow part

50 hollow connection part

60 measurement terminal

65 space

70 external case

71 vent

72a inlet

72b vent

73 space

74 cavity

80 block

80a housing

80b pierced part

90 spacer

90a hollow part

100 cell

200 battery assembly

300 battery module

1. A battery module, comprising:
a plurality of stacked battery assemblies, wherein each of the battery assemblies includes
a block including a plurality of housings each of which houses a plurality of cylindrical cells such that electrodes of the cells having an identical polarity are located at one side,
a first connection plate connecting the electrodes of the cells having the identical polarity in parallel,
a second connection plate connecting electrodes of the cells having the other polarity in parallel, and
a spacer disposed between the cells and the first connection plate,
the block has a pierced part penetrating the block along an axial direction,
the spacer has a hollow part extending outward from the first connection plate and penetrating the spacer along the axial direction,
adjacent ones of the battery assemblies disposed along a stacking direction are combined such that the pierced part of one of the adjacent ones of the battery assemblies is engaged with the hollow part of the other battery assembly, and
in the stacked battery assemblies, the pierced parts and the hollow parts of the battery assemblies communicate with each other along the axial direction.

2. The battery module of claim 1, wherein
an inner peripheral surface of the pierced part of the one of the adjacent ones of the battery assemblies is engaged with an outer peripheral surface of the hollow part of the other battery assembly.

3. The battery module of claim 1, wherein
the hollow part extends outward through a first opening formed in the first connection plate.

4. The battery module of claim 1, wherein
the hollow part of the other battery assembly is engaged with the pierced part of the one of the adjacent ones of the battery assemblies through a second opening formed in the second connection plate of the one of the adjacent ones of the battery assemblies.

5. The battery module of claim 1, wherein
the housings of the block are arranged around the pierced part.

6. The battery module of claim 1, wherein
the adjacent ones of the battery assemblies disposed along the stacking direction are combined with space provided along the axial direction.

7. The battery module of claim 6, wherein
one of electrodes of each of the cells has an aperture from which a gas generated in the cell is released to outside the cell, and
the gas released from the aperture of the cell is released to the space provided between the adjacent ones of the battery assemblies disposed along the stacking direction through a through hole formed in the first connection plate.

8. The battery module of claim 1, wherein
the first connection plate has a first connection terminal extending in a direction opposite to a direction toward the second connection plate,
the second connection plate has a second connection terminal extending in the same direction as that of the first connection terminal, and
the first connection terminal of one of the adjacent ones of the battery assemblies disposed along the stacking direction and the second connection terminal of the other battery assembly are in contact with each other and are connected to each other in series.

9. A battery assembly for use in the battery module of claim 1, the battery assembly comprising:
a block including a plurality of housings each of which houses a plurality of cylindrical cells such that electrodes of the cells having an identical polarity are located at one side;
a first connection plate connecting the electrodes of the cells having the identical polarity in parallel;
a second connection plate connecting electrodes of the cells having the other polarity in parallel; and
a spacer disposed between the cells and the first connection plate, wherein
the block has a pierced part penetrating the block along an axial direction,
the spacer has a hollow part extending outward from the first connection plate and penetrating the spacer along the axial direction, and
an outer diameter of the hollow parts is substantially equal to an inner diameter of the pierced part.

10. The battery assembly of claim 9, wherein
the hollow part extends outward through a first opening formed in the first connection plate.

11. The battery assembly of claim 9, wherein
the second connection plate has a second opening which is large enough to allow the hollow part to penetrate the second opening.

12. The battery assembly of claim 9, wherein
the housings of the block are arranged around the pierced part.

13. A battery module, comprising:
a plurality of battery assemblies which are stacked and in each of which a plurality of cells are arranged such that electrodes of the cells having an identical polarity are located at one side, wherein
each of the battery assemblies includes
a first connection plate connecting the electrodes of the cells having the identical polarity in parallel;
a second connection plate connecting electrodes of the cells having the other polarity in parallel, and
a cylindrical pierced part including a first pierced part and a second pierced part with different outer diameters,
the first pierced part extends outward through a first opening formed in the first connection plate,
adjacent ones of the battery assemblies disposed along a stacking direction are combined such that the first pierced part of one of the adjacent ones of the battery assemblies is engaged with the second pierced part of the other battery assembly, and
the pierced parts of the stacked battery assemblies communicate with each other along an axial direction.

14. The battery module of claim 13, wherein
an inner peripheral surface of the first pierced part of the one of the adjacent ones of the battery assemblies is engaged with an outer peripheral surface of the second pierced part of the other battery assembly.

15. The battery module of claim 13, wherein
the second pierced part of the other battery assembly is engaged with the first pierced part of the one of the adjacent ones of the battery assemblies through a second opening formed in the second connection plate of the one of the adjacent ones of the battery assemblies.

16. The battery module of claim 13, wherein
the cells are arranged around the pierced part.

17. The battery module of claim 13, wherein
the adjacent ones of the battery assemblies disposed along the stacking direction are combined with space provided along the axial direction.

18. The battery module of claim 17, wherein
one of electrodes of each of the cells has an aperture from which a gas generated in the cell is released to outside the cell, and
the gas released from the aperture of the cell is released to the space provided between the adjacent ones of the battery assemblies disposed along the stacking direction through a through hole formed in the first connection plate.

19. The battery module of claim 13, wherein
the first connection plate has a first connection terminal extending in a direction opposite to a direction toward the second connection plate,
the second connection plate has a second connection terminal extending in the same direction as that of the first connection terminal, and
the first connection terminal of one of the adjacent ones of the battery assemblies disposed along the stacking direction and the second connection terminal of the other battery assembly are in contact with each other and are connected to each other in series.

20. A battery assembly for use in the battery module of claim 13, the battery assembly comprising:
a plurality of cells arranged such that electrodes of the cells having an identical polarity are located at one side;
a first connection plate connecting the electrodes of the cells having the identical polarity in parallel;
a second connection plate connecting electrodes of the cells having the other polarity in parallel; and
a cylindrical pierced part including first and second pierced parts with different outer diameters, wherein
the first pierced part extends outward through a first opening formed in the first connection plate, and
an outer diameter of the first pierced part is substantially equal to an inner diameter of the second pierced part.

21. The battery assembly of claim 20, wherein
the second connection plate has a second opening which is large enough to allow the first pierced part to penetrate the second opening.

22. The battery module of claim 20, wherein
the cells are arranged around the pierced part.

23. A battery module, comprising:
a plurality of battery assemblies which are stacked and each of which a plurality of cells are arranged such that electrodes of the cells having an identical polarity are located at one side, wherein
each of the battery assemblies includes
a first connection plate connecting the electrodes of the cells having the identical polarity in parallel;
a second connection plate connecting electrodes of the cells having the other polarity in parallel, and
a cylindrical pierced part penetrating the first connection plate and the second connection plate,
adjacent ones of the battery assemblies disposed along a stacking direction are combined such that the pierced part of one of the adjacent ones of the battery assemblies is engaged with the pierced part of the other battery assembly with a cylindrical hollow connection part interposed therebetween, and
the pierced parts and the hollow connection parts of the stacked battery assemblies communicate with each other in an axial direction.

24. The battery module of claim 23, wherein
an outer peripheral surface of the hollow connection part is engaged with an inner peripheral surface of the pierced part of the one of the adjacent ones of the battery assemblies and an inner peripheral surface of the pierced part of the other battery assembly.
